(19) United States
(12) Patent Application Publication
(10) Pub. No.: US 2015/0007292 A1
(43) Pub. Date: Jan. 1, 2015

(54) USER AUTHENTICATION UTILIZING PATTERNS

(71) Applicant: International Business Machines Corporation, Armonk, NY (US)

(72) Inventors: Padmakumar A. Nambiar, Bangalore (IN); Lohith Ravi, Bangalore (IN); Lohitashwa Thyagaraj, Bangalore (IN)

(21) Appl. No.: 13/932,693

(22) Filed: Jul. 1, 2013

(51) Int. Cl. H04L 29/06

(52) U.S. Cl. CPC H04L 63/083
USPC 726/7

(57) ABSTRACT

A tool for performing a user authentication utilizing patterns. A first computing device receives a userid and password of a user attempting to access a secure resource using the first computing device. The first computing device determines a pattern. The pattern is determined at the time the userid and password of the user attempting to access the secure resource are received. The first computing device determines that the determined pattern matches a stored pattern of a user authorized to access the secured resource. The first computing device, in response to determining that the pattern matches the stored pattern, sends the userid and password to a second computing device for further authentication towards accessing the secure resource.

### FIELD OF THE INVENTION

The present invention relates generally to the field of computer security, and more particularly to user authentication.

### BACKGROUND OF THE INVENTION

Computer networks, particularly those with global reach such as the Internet, have greatly influenced the way that transactions are conducted, and the way data is stored and retrieved. With the growth of the Internet, user authentication has become increasingly important for both computer systems and networks. Secure access to computer systems and computer networks has been traditionally implemented using a user identification (userid) and password pair. This requires the user to protect their userid and password from unauthorized use. If the userid and password are not protected, accounts and files can be compromised. For example, if a first user knows the userid and password of a second user, then the first user may easily access the second user's account information. To hinder the unauthorized use of userids and passwords, a variety of alternative authentication schemes have been developed, such as those based on biometrics, random passwords, and graphical passwords.

### SUMMARY

Aspects of an embodiment of the present invention disclose a method, system, and a computer program product for performing a user authentication utilizing patterns. The method comprises a first computing device receiving a userid and password of a user attempting to access a secure resource using the first computing device. The method further comprises the first computing device determining a pattern, wherein the pattern is determined at the time the userid and password of the user attempting to access the secure resource are received. The method further comprises the first computing device determining that the determined pattern matches a stored pattern of a user authorized to access the secured resource. The method further comprises the first computing device, in response to determining that the pattern matches the stored pattern, sending the userid and password to a second computing device for further authentication towards accessing the secure resource.

### BRIEF DESCRIPTION OF THE SEVERAL VIEWS OF THE DRAWINGS

FIG. 1 is a functional block diagram illustrating a distributed data processing environment, including a server computer interconnected via a network with a mobile computing device, in accordance with one embodiment of the present invention.

FIG. 2 is a flowchart depicting operational steps of a pattern authentication program, executing within the distributed data processing environment of FIG. 1, for performing a client-side authentication of a user, in accordance with one embodiment of the present invention.

FIG. 3 is a flowchart depicting operational steps of a pattern authentication program, executing within the distributed data processing environment of FIG. 1, for performing a client-side authentication of a user, in accordance with another embodiment of the present invention.

FIG. 4 depicts a flowchart of the steps of a pattern set up program executing within the distributed data processing environment of FIG. 1, for defining and storing a pattern of an authorized user of a secure resource, in accordance with one embodiment of the present invention.

FIG. 5 depicts a block diagram of components of the server computer and the mobile computing device of FIG. 1, in accordance with one embodiment of the present invention.

### DETAILED DESCRIPTION

User authentication systems for online applications typically associate a user identifier (userid) and a password, which are sent from a computing device to a server computer over a network. The strength of such a method of user authentication may be based, to some extent, on the length and randomness of a password. Often, it is relatively easy for a third party to discover a password of a user, by guessing the password through trial and error, by using personal information about the user, or by an exhaustive search. In addition, keyboard entries that are shared over the network may not be secure, as a hacker may easily access data that is shared over the network.

Embodiments of the present invention recognize the value in an authentication method for performing a layer of client-side user authentication consisting of a client-side evaluation which authenticates the user as the owner of the account through a pattern via pattern recognition.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

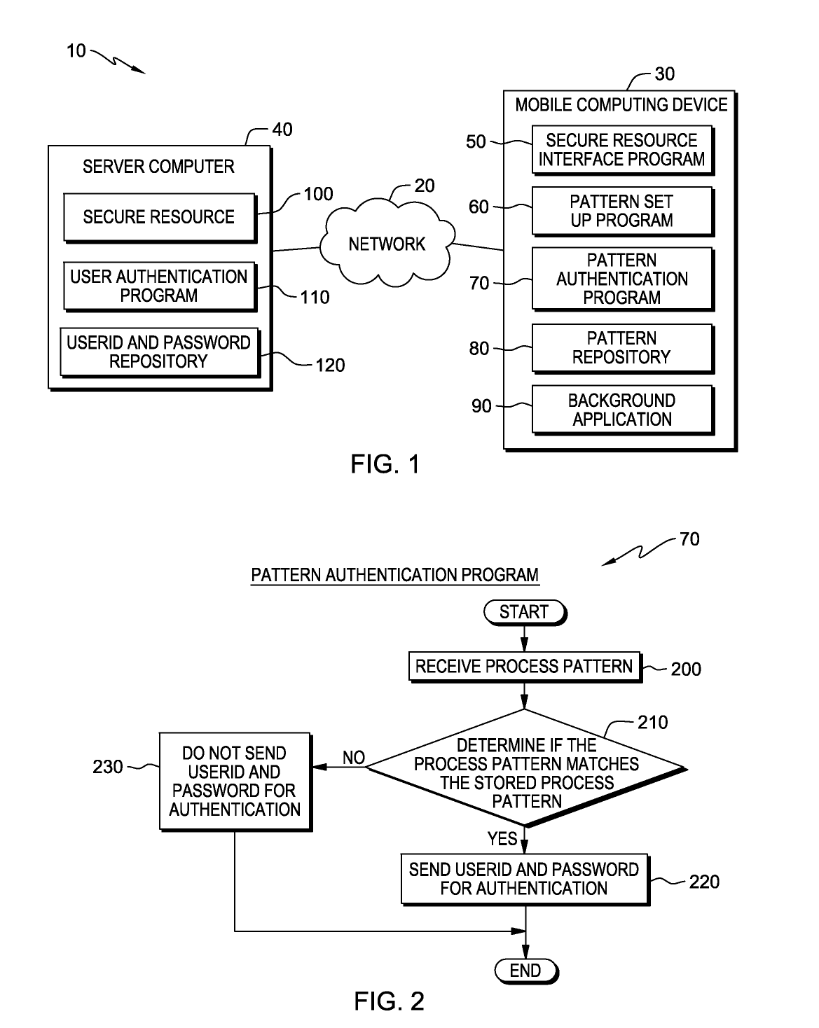

The present invention will now be described in detail with reference to the Figures. FIG. 1 depicts distributed data processing environment 10 in accordance with one embodiment of the present invention. FIG. 1 provides only an illustration of one embodiment and does not imply any limitations with regard to the environments in which different embodiments may be implemented.

In the depicted environment, distributed data processing environment 10 includes mobile computing device 30 and server computer 40 interconnected over network 20. Network 20 may be a local area network (LAN), a wide area network (WAN) such as the Internet, a combination thereof, or any combination of connections and protocols that will support communications between mobile computing device 30 and server computer 40 in accordance with embodiments of the present invention. Network 20 may include wired, wireless, or fiber optic connections. Distributed data processing environment 10 may include additional server computers, mobile computing devices, or other devices not shown.

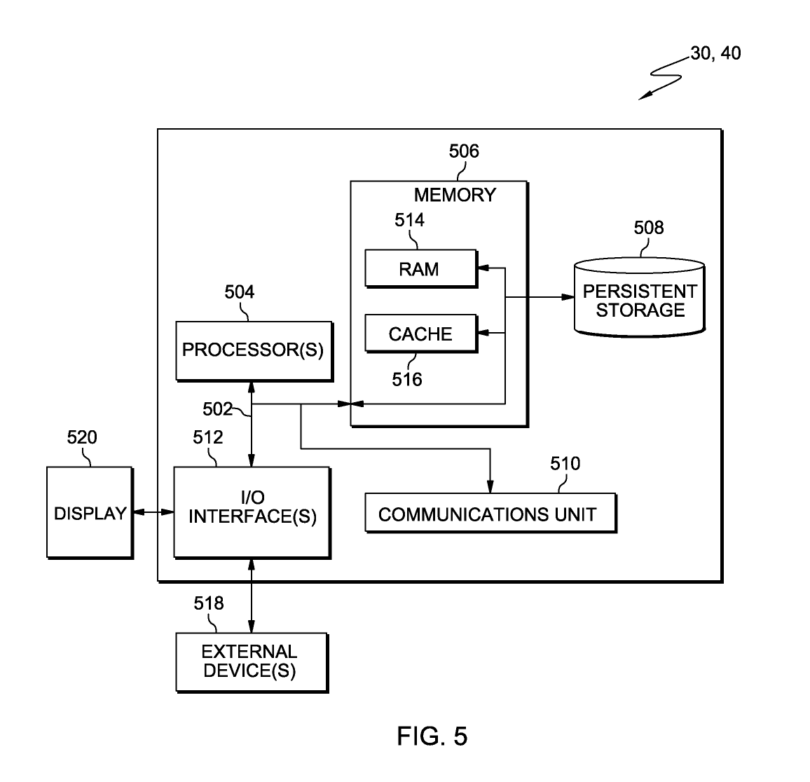

Server computer 40 may be a management server, web server, or any other electronic device or computing system capable of receiving and sending data and communicating with mobile computing device 30 over network 20. In other embodiments, server computer 40 may represent a server computing system utilizing multiple computers as a server system, such as in a cloud computing environment. Server computer 40 contains secure resource 100, user authentication program 110, and userid and password repository 120. Server computer 40 may include components as depicted and described in further detail with respect to FIG. 5.

Secure resource 100 may be a website, a database, a data structure, or any computer resource or device that requires user authentication to access. In one embodiment, secure resource 100 resides on server computer 40. In other embodiments, secure resource 100 may reside on another server or another computing device, provided that secure resource 100 is accessible to secure resource interface program 50.

User authentication program 110 operates to determine whether to grant a current user of mobile computing device 30 access to secure resource 100 by determining if a userid and password received from the current user matches a stored userid and password of an authorized user of secure resource 100. In one embodiment, user authentication program 110 accesses userid and password repository 120 and compares the userid and password sent by pattern authentication program 70 to the userids and corresponding passwords stored in userid and password repository 120.

In one embodiment, user authentication program 110 is a program residing on server computer 40. In other embodiments, user authentication program 110 may reside on another server or another computing device, provided that user authentication program 110 is accessible to secure resource interface program 50 and pattern authentication program 70, and has access to userid and password repository 120.

Userid and password repository 120 is a repository that may be written to and read by user authentication program 110. Userid and password repository 120 operates to store userids and corresponding passwords for users authorized to access secure resource 100. For example userid and password repository 120 may be a database. In one embodiment, userid and password repository 120 is located on server computer 40. In other embodiments, userid and password repository 120 may be located on another server computer or another computing device, provided that userid and password repository 120 is accessible to user authentication program 110.

Mobile computing device 30 may be a smart phone, tablet computer, laptop, desktop, or personal digital assistant (PDA). In general, mobile computing device 30 may be any electronic device or computing system capable of sending and receiving data and communicating with server computer 40 over network 20. Mobile computing device 30 contains secure resource interface program 50, pattern set up program 60, pattern authentication program 70, pattern repository 80, and background application 90. Mobile computing device 30 may include components as depicted and described in further detail with respect to FIG. 5.

Secure resource interface program 50 operates to visualize content, such as menus and icons, and to allow a user to interact with applications or resources accessible to mobile computing device 30 such as secure resource 100 over network 20. In one embodiment, secure resource interface program 50 may be a web browser. In other embodiments, secure resource interface program 50 may be an application on a smart phone, a security system program, or any other program that is capable visualizing content, such as menus and icons, and to allow a user to interact with applications or resources accessible to mobile computing device 30 such as secure resource 100 over network 20.

Pattern set up program 60 operates to define and store a pattern associated with an authorized user of secure resource 100. The pattern is used by pattern authentication program 70 during subsequent user authentication. During setup, pattern set up program 60 receives a pattern from a user authorized to access secure resource 100 (i.e., an authorized user) via a user computing device such as mobile computing device 30, and stores the received pattern in pattern repository 80. Pattern set up program 60 also operates to allow an authorized user to modify a previously created pattern that is stored in pattern repository 80.

In one embodiment, pattern set up program 60 sends a previously created pattern to server computer 40 to be stored for download to a new client (e.g., another mobile computing device not shown) or to a client that has been refreshed. The previously created pattern can also be sent to the new or refreshed client during a first authentication of the new or refreshed client. In one embodiment, when an authorized user attempts to access secure resource 100 from the new or refreshed client, the stored pattern is downloaded from server computer 40 to the new or refreshed client. The downloaded pattern may be stored in a pattern repository (not shown) on the new or refreshed client (not shown) along with the associated userid and password of the authorized user. The downloaded pattern stored in the pattern repository, on the new or refreshed client, is used by a pattern authentication program, such as pattern authentication program 70, operating on the new or refreshed client.

In one embodiment, pattern set up program 60 resides on mobile computing device 30. In other embodiments, pattern set up program 60 may reside on another computing device, server, or any computing device provided that pattern set up program 60 can communicate with secure resource interface program 50 and pattern authentication program 70.

In certain embodiments, a pattern includes a password typing pattern, a process pattern, or any other type of pattern. In one embodiment, a password typing pattern may be a sequence of keystrokes by a user to enter his or her password. The password typing pattern includes additional keystrokes that are not part of the password itself. For example, if a user's password is “xyz”, the user may enter the password by typing keystrokes in the following sequence: <x><a><backspace><y><left arrow><right arrow><z>. The additional keystrokes do not compromise the integrity of the password, which remains “xyz”, but the unique sequence of keystrokes can be evaluated by pattern authentication program 70.

In certain embodiments, a process pattern is defined as any requirement that is related with the state of the client computer or processes operating on the client computer. The process pattern is used to authenticate a user on the client-side after which a secured channel to the server is enabled. Such embodiments can include a mechanism of allowing a user, authorized to access secured resource 100, to establish a relationship by invoking/altering processes to generate a client-side authentication script. In some cases, a user authorized to access secure resource 100 may require that one or more applications on mobile computing device 30 are operating at the time that a user enters his or her userid and password. For example, the user selects background application 90 using pattern set up program 60. When the user enters his or her userid and password when attempting to access secure resource 100 from mobile computing device 30, background application 90 must be operating at the same time in order for the user to access secure resource 100.

In yet another embodiment, a pattern can be any type of action that can be performed on mobile computing device 30 while the userid and password are entered. For example, a pattern may require the user to open an image before the user enters his or her password. In another example, the pattern can include opening a notebook application and typing the letters “abc” before the userid and password are entered. In such a case, when the user enters his or her userid and password the selected application must be open and the application must contain the letters “abc”, in the correct sequence, in order for the user to, for example, access secure resource 100 via mobile computing device 30. Such embodiments are not limited to the use of only Ascii characters. Such embodiments can include other, established patterns based on, for example, entering client data along with making certain selections, such as selecting certain checkboxes. Such embodiments can also include image validation. Still other embodiments require certain events to occur in a specific order. For example, an image validation must be performed before a password is entered.

Pattern authentication program 70 operates to perform a client-side authentication of a user of mobile computing device 30 attempting to access secure resource 100. Pattern authentication program 70 determines whether to send the password of a user of mobile computing device 30 attempting to access secure resource 100 for further authentication. For example, secure resource 100 further authenticates the userid and password entered by the user sending the userid and password to user authentication program 110 on server computer 40, which will be discussed in more detail below. User authentication program 110 compares the received In one embodiment, pattern authentication program 70 determines if a pattern entered by a user operating mobile computing device 30 matches a stored pattern of an authorized user of secure resource 100. In one embodiment, pattern authentication program 70 accesses pattern repository 80 and compares the received pattern with the stored pattern of the authenticated user.

If pattern authentication program 70 determines that the received pattern matches the stored pattern, then pattern authentication program 70 sends the userid and password of the user to user authentication program 110 for further authentication.

Pattern repository 80 is a repository that may be written to and read by pattern set up program 60 and read by pattern authentication program 70. Pattern repository 80 operates to store a pattern, selected by a user authorized to access secure resource 100, for use by pattern authentication program 70. For example, pattern repository 70 may be a database. In one embodiment, pattern repository 80 is located on mobile computing device 30.

Background application 90 is an application that, in one embodiment, a user may select as part of a process pattern to be used by pattern authentication program 70 during user authentication. In certain embodiments, background application 90 is an application that operates on mobile computing device 30, such as an e-mail application, a social networking application, a notepad application, etc.

FIG. 2 is a flowchart depicting operational steps of pattern authentication program 70 for performing a client-side authentication of a user of mobile computing device 30 attempting to access secure resource 100, in accordance with one embodiment of the present invention.

In this embodiment, a user authorized to access secure resource 100 can select a process pattern to be used by pattern authorization program 70 during client-side user authentication. A user authorized to access secure resource 100, using secure resource interface program 50 on mobile computing device 30, has selected pattern authentication program 70 to operate as client-side authentication when any user attempts to access secure resource 100 from mobile computing device 30. In this embodiment, pattern authentication program 70 operates as a client side authentication. For example, pattern authentication program 70 operates to authenticate a user operating mobile computing device 30. The user authorized to access secure resource 100, using pattern set up program 60, has selected background application 90 as an application that is required to operate at the same time that the user enters his or her userid and password in order to access secure resource 100.

In this scenario, the user, using secure resource interface program 50, enters his or her userid and password. Secure resource interface program 50 takes a snapshot of the programs that are operating on mobile computing device 30 when the user entered his or her userid and password. Secure resource interface program 50 sends the snapshot to pattern authentication program 70. The snapshot may include the application that is required to operate at the same time that the user enters his or her userid and password (e.g., the process pattern) in order to access secure resource 100.

In step 200, pattern authentication program 70 receives, from secure resource interface program 50 over network 20, the process pattern. In this embodiment, the process pattern is included in the snapshot of the programs that are operating on mobile computing device 30 at the time the user entered his or her userid and password. In another embodiment, when a user attempts to access secure resource 100 from mobile computing device 30 for a first time, the stored process pattern is downloaded from server computer 40 and stored in pattern repository 80.

Pattern authentication program 70 determines if the received process pattern of the user authorized to access secure resource 100 matches the stored process pattern (decision 210). In one embodiment, pattern authentication program 70 accesses pattern repository 80 to retrieve the stored process pattern of the user authorized to access secure resource 100. Pattern authentication program 70 compares the stored process pattern with the received process pattern. For example, in this embodiment, the stored process pattern of the user authorized to access secure resource 100 includes a requirement that background application 90 is to be operating at the same time that the user enters his or her userid and password in order to access secure resource 100. Pattern authentication program 70 searches the received snapshot of the programs that were operating on mobile computing device 30 when the user entered his or her userid and password to determine if background program 90 was operating. If background application 90 was operating, the received process pattern is determined to match the stored process pattern.

If pattern authentication program 70 determines that the received process pattern matches the stored process pattern (decision 210, Yes branch), then pattern authentication program 70 proceeds to step 220. If pattern authentication program 70 determines that the received process pattern does not match the stored process pattern (decision 210, No branch), then pattern authentication program 70 proceeds to step 230.

In step 230, in one embodiment, pattern authentication program 70 ends. In another embodiment, in step 230, pattern authentication program 70 sends a notification to secure resource interface program 50 to indicate that the password typing pattern entered by the user is not correct, and prompts the user to re-enter his or her password using another password typing pattern.

If pattern authentication program 70 determines that the received process pattern does match the stored process pattern (decision 210, Yes branch), then pattern authentication program 70 sends the userid and password of the user attempting to access secure resource 100 to user authentication program 110 for further authentication, in step 220.

User authentication program 110 receives the userid and password and accesses userid and password repository 120. User authentication program 110 compares the userid and password stored in password repository 120 to the userid and password that were received by user authentication program 110. If the userid and password received by user authentication 110 match the stored userid and password of the user authorized to access secure resource 100 in password repository 120, then the user is granted access to secure resource 100. If the userid and password received by user authentication program 110 do not match the stored userid and password of a user authorized to access secure resource 100 in password repository 120, then the user is not granted access secure resource 100.

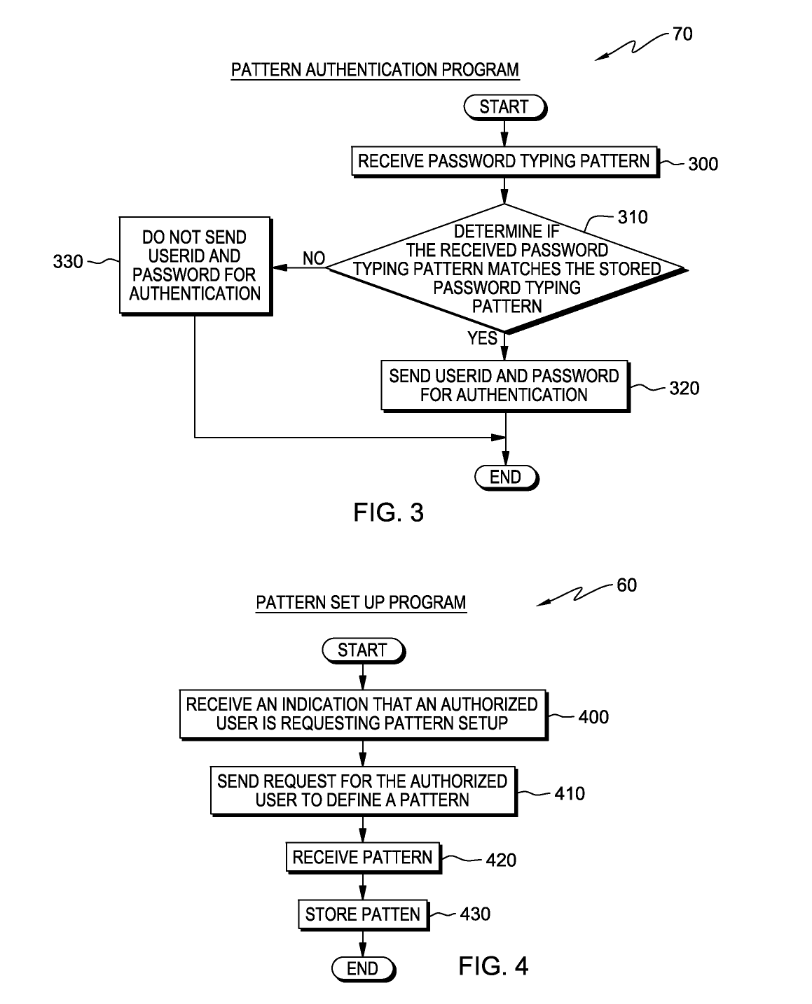

FIG. 3 is a flowchart depicting operational steps of pattern authentication program 70 for performing a client-side authentication of a user of mobile computing device 30 attempting to access secure resource 100, in accordance with another embodiment of the present invention.

In this embodiment, a user authorized to access secure resource 100 can configure pattern authentication program 70 to operate as client-side authentication when any user attempts to access secure resource 100 from mobile computing device 30. For example, pattern authentication program 70 operates to authenticate a user operating mobile computing device 30. In this embodiment, a user authorized to access secure resource 100 has configured pattern authentication program 70 to determine if a received password typing pattern matches a stored password typing pattern. As part of this configuration, the user authorized to access secure resource 100, using pattern set up program 60, has defined and stored a password typing pattern. In such a configuration, the defined and stored password typing pattern is required to be entered at the time the user enters his or her userid and password in order to access secure resource 100.

A user, using secure resource interface program 50, enters his or her userid and password using a particular password typing pattern in order to access secure resource 100. In this embodiment, secure resource interface program 50 sends the userid and password, which are entered using a particular password typing pattern, to pattern authentication program 70.

In step 300, pattern authentication program 70 receives the password typing pattern. In this embodiment, the particular password typing pattern entered by the user, using secure resource interface program 50, is the received pattern. In another embodiment, pattern authentication program 70 receives only the userid and password of the user entered in order to access secure resource 100. Pattern authentication program 70 sends a request, to secure resource interface program 50, for the password typing pattern. Secure resource interface program 50 sends the password typing pattern to pattern authentication program 70. Secure resource interface program 50 monitors and stores the keystrokes that are entered by the user. Upon receiving the request from pattern authentication program 70, secure resource interface program 50 sends the stored keystrokes to pattern authentication program 70. In another embodiment, when a user attempts to access secure resource 100 from mobile computing device 30 for a first time, the stored password typing pattern is downloaded from server computer 40 and stored in pattern repository 80.

Pattern authentication program 70 determines if the received password typing pattern matches the stored password typing pattern of the user authorized to access secure resource 100 (decision 310). In one embodiment, pattern authentication program 70 accesses pattern repository 80 and retrieves the stored password typing pattern of the user authorized to access secure resource 100. Pattern authentication program 70 compares the received password typing pattern to the stored password typing pattern. If pattern authentication program 70 determines that the received password typing pattern matches the stored password typing pattern (decision 310, Yes branch), then pattern authentication program 70 proceeds to step 320. If pattern authentication program 70 determines that the received password typing pattern does not match the stored password typing pattern (decision 310, No branch), then pattern authentication program 70 proceeds to step 330.

In step 330, pattern authentication program 70 does not send the userid and password of the user attempting to access secure resource 100 to user authentication program 110. In one embodiment, pattern authentication program 70 ends. In another embodiment, pattern authentication program 70 sends a notification to secure resource interface program 50 to indicate that the password typing pattern entered by the user is not correct, and prompts the user to re-enter his or her password using another password typing pattern.

In step 320, pattern authentication program 70 sends the userid and password of the user attempting to access secure resource 100 to user authentication program 110 for further authentication.

User authentication program 110 receives the userid and password and accesses userid and password repository 120 to compare the userid and password stored in password repository 120 with the userid and password that were received by user authentication program 110. If the userid and password received by user authentication 110 match a stored userid and password of a user authorized to access secure resource 100 in password repository 120, the user is granted access to secure resource 100. If the userid and password received by user authentication program 110 do not match a stored userid and password of a user authorized to access secure resource 100 in password repository 120, the user is not granted access secure resource 100.

FIG. 4 depicts a flowchart of the steps of operational steps of pattern set up program 60 for defining and storing a pattern of an authorized user of secure resource 100, in accordance with an embodiment of the present invention.

An authorized user (i.e., a user authorized to access secure resource 100) selects a pattern setup function in secure resource interface program 50 on a user computing device, such as mobile computing device 30. In response to the selection, secure resource interface program 50 sends, to pattern set up program 60, an indication that the authorized user is requesting pattern setup.

In step 400, pattern set up program 60 receives, from secure resource interface program 50, the indication that the authorized is requesting pattern setup. In the depicted embodiment, the userid and password are the userid and password required to authenticate the user to access secure resource 100.

In response to receiving the indication of the pattern setup request, pattern setup program 60 sends to secure resource interface program 100 a request for the authorized user to define a pattern (step 410). In one embodiment, the user creates a typing pattern. For example, the user enters his or her password and enters one or more additional keystrokes that do not change the password. In another embodiment, the user creates a process pattern. For example, the user selects one or more applications to be operating at the time that a user enters his or her userid and password. The user, using secure resource interface program 50, defines what the pattern is and secure resource interface program 50 sends the defined pattern to pattern set up program 60.

In step 420, pattern set up program 60 receives the defined pattern. In step 430, pattern set up program 60 stores the defined pattern such that the defined pattern corresponds to the userid and password of the user authorized to access secure resource 100. In one embodiment, pattern set up program 60 stores the received pattern to pattern repository 80.

FIG. 5 depicts a block diagram of components of mobile computing device 30 and server computer 40, in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Mobile computing device 30 and server computer 40 each include communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media.

Secure resource interface program 50, pattern set up program 60, pattern authentication program 70, pattern repository 80, and background application 90 are stored in persistent storage 508 of mobile computing device 30 for execution and/or access by one or more of the respective computer processors 504 of mobile computing device 30 via one or more memories of memory 506 of mobile computing device 30. Secure resource 100, user authentication program 110, and userid and password repository 120 are stored in persistent storage 508 of server computer 40 for execution and/or access by one or more of the respective computer processors 504 of server computer 40 via one or more memories of memory 506 of server computer 40. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other servers or devices. In these examples, communications unit 510 includes one or more network interface cards. Communications unit 510 may provide communications through the use of either or both physical and wireless communications links. Secure resource interface program 50, pattern set up program 60, pattern authentication program 70, pattern repository 80, and background application 90 may be downloaded to persistent storage 508 of mobile computing device 30, respectively, through the respective communications unit 510 of mobile computing device 30. Secure resource 100, user authentication program 110, and userid and password repository 120 may be downloaded to persistent storage 508 of server computer 40 through communications unit 510 of server computer 40.

I/O interface(s) 512 allows for input and output of data with other devices that may be connected to mobile computing device 30 or server computer 40. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention, e.g., secure resource interface program 50, pattern set up program 60, pattern authentication program 70, pattern repository 80, and background application 90, can be stored on such portable computer-readable storage media and can be loaded onto persistent storage 508 of mobile computing device 30, respectively, via the respective I/O interface(s) 512 of mobile computing device 30. Software and data used to practice embodiments of the present invention, e.g. secure resource 100, user authentication program 110, and userid and password repository 120, can be stored on such portable computer-readable storage media and can be loaded onto persistent storage 508 of server computer 40 via I/O interface(s) 512 of server computer 40. I/O interface(s) 512 also connect to a display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer program product for performing a user authentication utilizing patterns, the computer program product comprising:
one or more computer-readable storage media and program instructions stored on the one or more computer-readable storage media, the program instructions comprising:
program instructions to receive, by a first computing device, a userid and password of a user attempting to access a secure resource using the first computing device;
program instructions to determine, by the first computing device, a pattern, wherein the pattern is determined at the time the userid and password of the user attempting to access the secure resource are received;
program instructions to determine, by the first computing device, that the determined pattern matches a stored pattern of a user authorized to access the secure resource; and
program instructions to send, by the first computing device, the userid and password to a second computing device for further authentication towards accessing the secure resource in response to determining that the pattern matches the stored pattern.

2. The computer program product of claim 1, wherein the pattern comprises a sequence of keystrokes entered by the user attempting to access the secure resource, wherein the sequence of keystrokes includes the password of the user and additional keystrokes that are not part of the password of the user.

3. The computer program product of claim 1, wherein the pattern comprises a requirement relating to the state of the first computing device at the time the userid and password of the user attempting to access the secure resource are received.

4. The computer program product of claim 3, wherein the requirement comprises a program that must be running on the first computing device at the time the userid and password of the user attempting to access the secure resource are received.

5. The computer program product of claim 1, further comprising:
program instructions, stored on the one or more computer-readable storage media, to receive, by the first computing device, an indication that the user authorized to access the secure resource is requesting pattern setup;
program instructions, stored on the one or more computer-readable storage media, to receive, by the first computing device, the pattern of the user authorized to access the secure resource; and
program instructions, stored on the one or more computer-readable storage media, to store, by the first computing device, the pattern of the user authorized to access the secure resource.

6. The computer program product of claim 5, further comprising program instructions, stored on the one or more computer-readable storage media, to send, by the first computing device, the pattern of the user authorized to access the secure resource to the second computing device.

7. A computer system for performing a user authentication utilizing patterns, the computer system comprising:
one or more computer processors;
one or more computer-readable storage media;
program instructions stored on the computer-readable storage media for execution by at least one of the one or more processors, the program instructions comprising:
program instructions to receive, by the system, a userid and password of a user attempting to access a secure resource using the system;
program instructions to determine, by the system, a pattern, wherein the pattern is determined at the time the userid and password of the user attempting to access the secure resource are received;
program instructions to determine, by the system, that the determined pattern matches a stored pattern of a user authorized to access the secure resource; and
program instructions to send, by the system, the userid and password to a second computing device for further authentication towards accessing the secure resource in response to determining that the pattern matches the stored pattern.

8. The computer system of claim 7, wherein the pattern comprises a sequence of keystrokes entered by the user attempting to access the secure resource, wherein the sequence of keystrokes includes the password of the user and additional keystrokes that are not part of the password of the user.

9. The computer system of claim 7, wherein the pattern comprises a requirement relating to the state of the first computing device at the time the userid and password of the user attempting to access the secure resource are received.

10. The computer system of claim 9, wherein the requirement comprises a program that must be running on the first computing device at the time the userid and password of the user attempting to access the secure resource are received.

11. The computer program product of claim 7, further comprising:
program instructions, stored on the computer-readable storage media for execution by at least one of the one or more processors, to receive, by the system, an indication that the user authorized to access the secure resource is requesting pattern setup;
program instructions, stored on the computer-readable storage media for execution by at least one of the one or more processors, to receive, by the system, the pattern of the user authorized to access the secure resource; and
program instructions, stored on the computer-readable storage media for execution by at least one of the one or more processors, to store, by the system, the pattern of the user authorized to access the secure resource.

12. The computer program product of claim 11, further comprising program instructions, stored on the computer-readable storage media for execution by at least one of the one or more processors, to send, by the system, the pattern of the user authorized to access the secure resource to the second computing device.
